(19) United States
(12) Patent Application Publication
(10) Pub. No.: US 2004/0158848 A1
(43) Pub. Date: Aug. 12, 2004

(54) Optical disk and method for manufacturing the same

(75) Inventor: Yasuaki Ootera, Kawasaki-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/743,561

(22) Filed: Dec. 23, 2003

(30) Foreign Application Priority Data
Dec. 27, 2002 (JP) 2002-380278

(51) Int. Cl. G11B 7/24

(52) U.S. Cl. 720/718

(57) ABSTRACT

In an optical disk, a recording film and a reflection film have different inner diameters. The optical disk includes a printed label having an inner diameter greater than the inner diameter of the reflection film. The inner diameter of the label is smaller than that of the recording film. An adhesive layer is directly in contact with first and second substrates. Therefore, sufficient adhesion strength is assured.

### CROSS-REFERENCE TO RELATED APPLICATIONS

This application is based upon and claims the benefit of priority from the prior Japanese Patent Application No. 2002-380278 filed Dec. 27, 2002, the entire contents of which are incorporated herein by reference.

### BACKGROUND OF THE INVENTION

1. Field of the Invention

The present invention relates to an information recording medium, in/from which information can be recorded/reproduced using a laser beam, and which has a larger label surface for indicating visible information. The present invention also relates to a method for manufacturing such an information recording medium.

2. Description of the Related Art

Optical disks have been widespread, which include a play-only type typified by a CD and DVD-ROM, a write-once type typified by a CD-R and DVD-R, and a rewritable type typified by an external memory for a computer and a recording/playback videodisk.

The optical disks are widely used to provide music, video and educational software. Graphics and background images indicated on the label surface available to the user have also attracted public attention.

The optical disk such as a CD or a DVD-ROM has a clamp hole (central hole) of a diameter of 15 mm, and the information recording area thereof has an inner diameter of 46 mm. Since the diameter of the disk is 120 mm, about ⅛ of the area of the label surface cannot bear visible information, even if the label surface is formed on all over the back surface of the information recording area.

Jpn. Pat. Appln. KOKAI Publication No. 9-7233 (Abstract A) discloses an optical disk in which information is recorded near the central hole. To form this optical disk, first, paired transparent circular substrates, having a non-record region in an inner peripheral portion around the central hole, face each other. The facing surfaces of the circular substrates adhere to each other by adhesive with a sheet member sandwiched therebetween. A region of the sheet member, facing the non-record region of the circular substrate, has an indicating part for indicating information relating to the recording area of the optical disk.

In the invention disclosed in the above patent publication, when a label or the like is to be indicated in the non-record area in the inner peripheral portion around the central hole, the label is not printed on the surface but a sheet including the label is sandwiched between the substrates. However, it is practically difficult to sandwich a sheet between the two substrates.

There is no technical problem in increasing the area of a label. However, if the label is printed on an inner peripheral portion, the undersurface of the label can be seen from the side of the recording area (the back side of the label surface). Such a disk is not visually favorable.

To make the appearance of the disk more favorable, the recording film may be extended to the central hole. In this case, however, the following problem arises: since great stress is applied to the portion near the central hole of the disk when the disk is attached (clamped) to and removed from the disk drive apparatus, the recording film near the central hole may be peeled off.

There is another problem. Particularly in a disk of adhesion type, the portion near the central hole requires mechanical strength. However, in the case where a recording film is formed near the central hole, the adhesion area is not as much as necessary and sufficient adhesion strength cannot be obtained.

### BRIEF SUMMARY OF THE INVENTION

An object of the present invention is to provide a recording medium, in which an indication area for indicating visible information is increased and the mechanical strength of the central portion for clamping is assured, and to provide a method for manufacturing such a recording medium.

According to a first aspect of the present invention, there is provided a rewritable laminated optical disk having a first substrate including a rewritable recording film and a reflection film which reflects light radiated from the recording film, and a second substrate including a visible information indicating region, the first and second substrates being adhered to each other by an adhesive layer, wherein the recording film in the first substrate has an inner periphery having a radius of 16 mm to 24 mm, and the reflection film has an inner periphery having a radius of 11 mm to 15 mm.

According to a second aspect of the present invention, there is provided a recording medium comprising: a first substrate, a reflection film which reflects light and has an inner periphery at a predetermined distance outside from a central hole and a recording film which records information upon radiation of light thereon and has an inner periphery at a predetermined distance outside from the reflection film; a second substrate having an opening substantially concentric to the central hole of the first substrate and substantially same in diameter as the central hole, and a visible information indicating region which has an inner periphery at a predetermined distance outside from the reflection film; and an adhesive layer which is interposed between the first and second substrates and adheres the first and second substrates such that the opening substantially coincides with the central hole.

According to a third aspect of the present invention, there is provided an optical disk manufacturing method for manufacturing an optical disk of rewritable laminated type, comprising: forming a recording film on a first substrate with a first mask covering at least a central hole of the optical disk; and forming a reflection film on the first substrate with a second mask covering at least the central hole and having a radius different from that of the first mask.

According to a fourth aspect of the present invention, there is provided an optical disk manufacturing method comprising: forming a first thin film on a first substrate having predetermined outer and inner diameters with a first mask of a first radius arranged near a central hole of the first substrate, the first substrate having pits corresponding to physical information and a guide groove; forming a second thin film on the first substrate with a second mask in place of the first mask, the second mask having a second radius smaller than the first radius; applying a predetermined amount of adhesive to at least one of the second thin film and an exposed portion of the first substrate; superposing a second substrate on the first substrate in association with the central hole of the first substrate and hardening the adhesive; and recording visible information on a non-adhesive surface of the second substrate, thereby forming a visible information indicating region.

According to a fifth aspect of the present invention, there is provided a recording medium manufacturing method comprising: forming a first thin, film on a first substrate having predetermined outer and inner diameters with a first mask of a first radius arranged near a central hole of the first substrate; thereafter exchanging the first mask with a second mask having a second radius smaller than the first radius; and thereafter forming a second thin film on the first substrate.

### BRIEF DESCRIPTION OF THE SEVERAL VIEWS OF THE DRAWING

FIG. 1 is a schematic diagram illustrating an optical disk according to an embodiment of the present invention;

FIGS. 2A to 2E are schematic diagrams illustrating steps for manufacturing the optical disk shown in FIG. 1;

FIGS. 3A to 3C are schematic diagrams illustrating steps for manufacturing the optical disk subsequent to the steps shown in FIGS. 2A to 2E; and

FIGS. 4A to 4E are schematic diagrams illustrating steps for manufacturing the optical disk subsequent to the steps shown in FIGS. 3A to 3C.

### DETAILED DESCRIPTION OF THE INVENTION

An embodiment of the present invention will be described in detail with reference to the accompanying drawings.

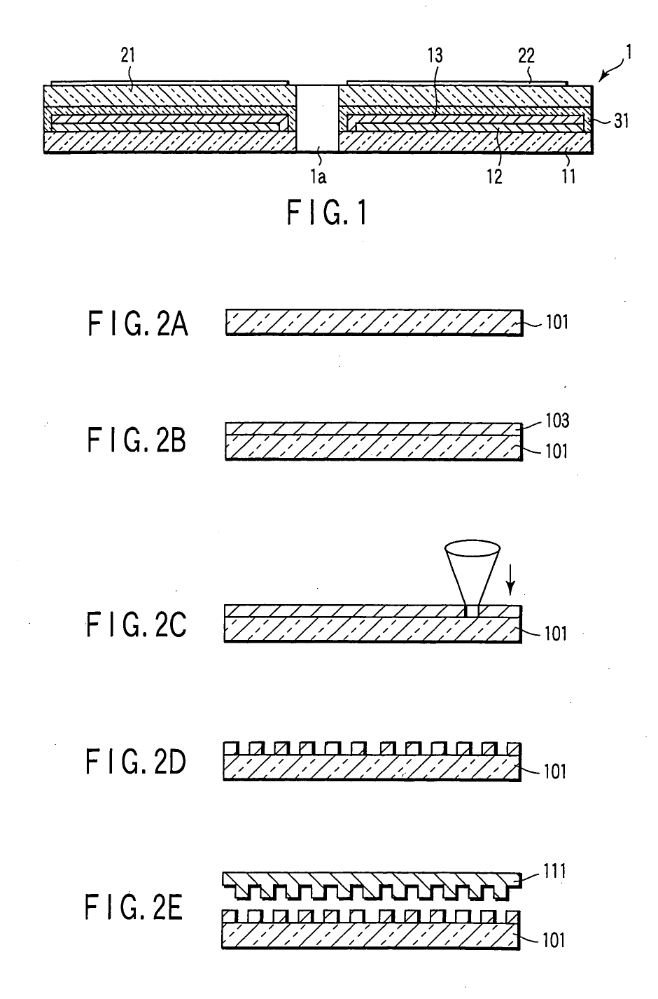

FIG. 1 is a cross-sectional view illustrating a recording medium to which an embodiment of the present invention can be applied.

As shown in FIG. 1, an optical disk 1, as a recording medium, includes a first substrate 11 on which a rewritable recording film of the DVD standard is formed, a second substrate 21 on which a label region (label surface) for indicating visible information is formed, and an adhesive layer 31 adhering the two substrates 11 and 21. A central hole 1a of a diameter of 15 mm is formed at the center of the optical disk 1, i.e., the first and second substrates. Each of the substrates 11 and 21 is 120 mm in diameter and 0.6 mm in thickness. The total thickness of the disk 1, including the adhesive layer 31, is about 1.2 mm.

A recording film 12 and a reflection film 13 for reflecting a recording optical beam radiated on the recording film 12 are laminated on the first substrate 11 in this order. The reflection film 13 covers the recording film 12. The inner periphery of the reflection film 13 forms a circle of a radius of, for example, 12 mm.

Visible information such as a label 22, typified by images or graphic arts, is formed on the second substrate 21 by, for example, printing. The inner periphery of the label 22 forms a circle of a radius of, for example, 13 mm.

Therefore, when the optical disk 1 is viewed from the side of the recording film 12, i.e., the bottom of the sheet of the FIG. 1, a transparent ring portion having a width of 4.5 mm is seen between the periphery of the central hole 1a and the inner periphery of the reflection film 13. Then, the reflection film 13 around the transparent ring portion is seen. The recording film 12 is seen around the reflection film 13, from the portion about 23 mm apart from the center of the disk. The label 22 located on the rear side of the disk, i.e., the non-adhesive side of the second substrate 21, cannot be seen at all. The adhesive layer 31 directly connects the first and second substrates 11 and 21 in a central portion around the central hole 1a, where no reflection film 13 is formed. Therefore, the strength of the clamping portion around the central hole is increased.

FIGS. 2A to 2E, 3A to 3C and 4A to 4E are schematic diagrams illustrating steps for manufacturing the optical disk shown in FIG. 1. The steps shown in the respective figures basically correspond to operations of an apparatus for manufacturing a recording medium, though not described in detail.

First, referring to FIG. 2A, a glass disk as a master disk 101 is prepared. The surface of the glass master disk 101 has been polished to predetermined roughness and washed.

Then, as shown in FIG. 2B, photoresist 103 is applied to the surface of the glass master disk 101. Thereafter, as shown in FIG. 2C, a laser beam of a predetermined wavelength is applied to the glass master disk. As a result, physical information (a header) or a guide groove (pit) or the like is recorded.

Thereafter, the exposed glass master disk 101 is developed, so that the undeveloped portion of the photoresist is removed. As a result, projections and depressions, e.g., pits, as shown in FIG. 2D, are formed.

The glass master disk 101 is plated, thereby forming a stamper 111 as shown in FIG. 2E.

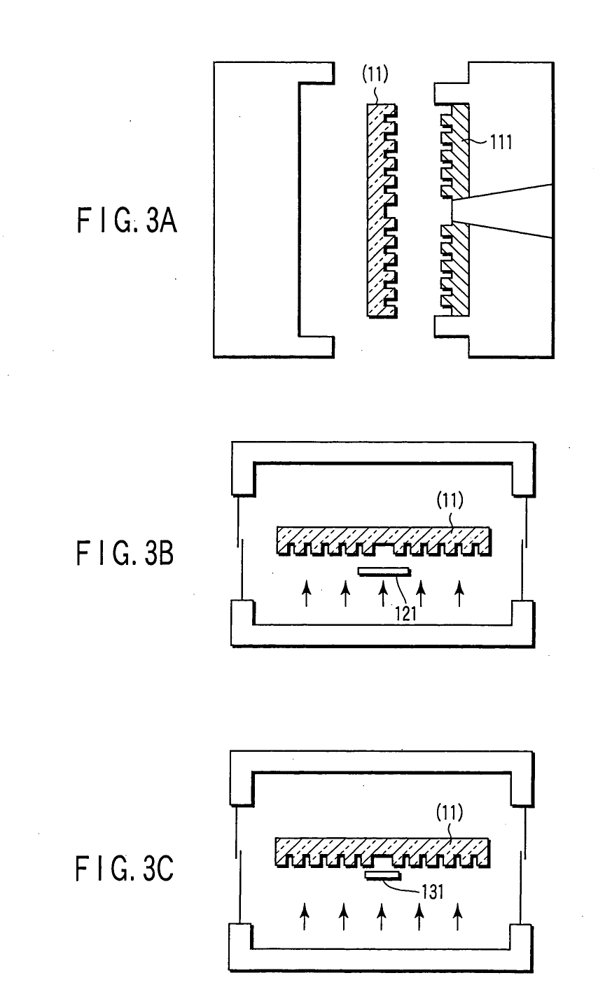

Then, as shown in FIG. 3A, a resin-molded plate (corresponding to the first and second substrates 11 and 21 shown in FIG. 1) is formed by using the stamper as a mold. In general, the substrate (11, 21) is made of polycarbonate.

Thereafter, as shown in FIG. 3B, a material of the recording film 12 is deposited to a predetermined thickness on the resin-molded plate corresponding to the first substrate 11 by, for example, sputtering. The sputtering is performed by using a first mask 121, which masks the region other than the region to be the recording film 12. The recording film is formed outside a circle of a radius r=23 mm.

Then, the first mask 121 is replaced with a second mask 131, which masks the region other than the region to be the reflection film 13. A material of the reflection film 13 is deposited to a predetermined thickness on the resin-molded plate by, for example, sputtering, so that the reflection film 13 is formed outside a circle of a radius r=12 mm.

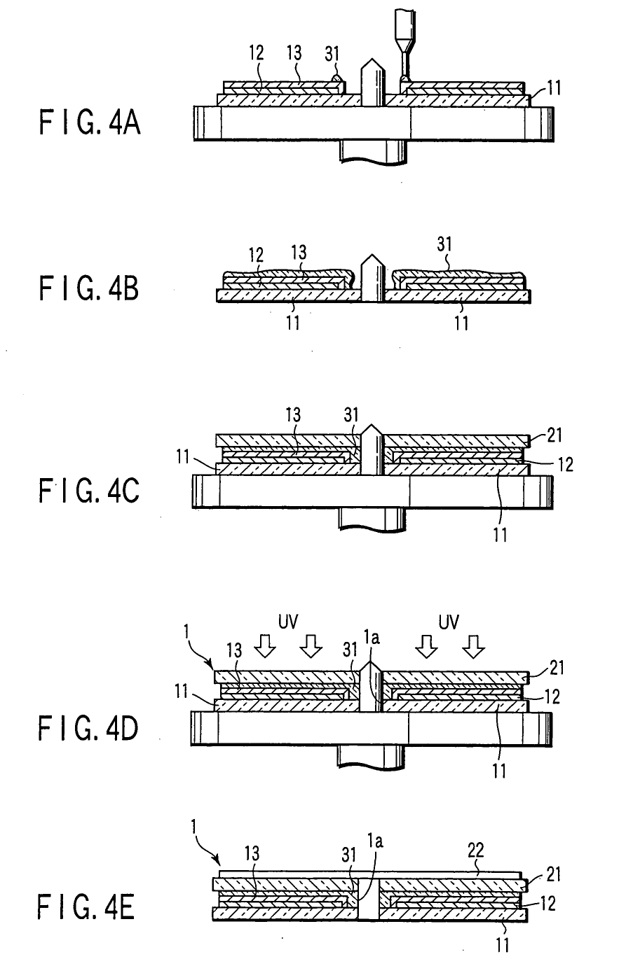

The substrate 11 is mounted on a turntable of a spinner (which is not described in detail), as shown in FIG. 4A. Adhesive of a predetermined amount to be an adhesive layer 31 is supplied to the substrate 11. The adhesive is, for example, a UV hardening resin, which is hardened when radiated with ultraviolet light.

The turntable is rotated for a predetermined duration at the number of revolutions for leveling. As a result, the UV hardening resin is spread to a substantially uniform thickness, as shown in FIG. 4B.

Thereafter, as shown in FIG. 4C, the second substrate 21, which has been prepared in advance in a separate step, is set on the first substrate 11. At this time, the rear surface of the second substrate 21, that is, the backside of the label surface, faces the surface of the first substrate 11 on which the UV hardening resin is spread.

Then, although not shown in the figures, an excess of the adhesive sandwiched between the two substrates is removed by a high-speed rotation of the turntable (an excess adhesive removing step).

Ultraviolet (UV light) is applied to the substrates, with the result that the two substrates (11, 21) are adhered to each other, as shown in FIG. 4D.

Then, as shown in FIG. 4E, the label 22 is printed on the second substrate 21 by a printing step (not shown). As described before with reference to FIG. 1, the label 22 is printed on the region outside the circle of the radius r=13 mm. In this case, the area, on which visible information cannot be printed, is only 1/20 of all area of the label surface.

The minimum value of the radius of the inner periphery of the recording film described above with reference to FIG. 3B is determined by the standard set in a recording/reproducing apparatus (not shown) or the diameter of the central hole specific to the optical disk. The radius r of the inner periphery of the recording film may be about 15 mm. So far as the compatibility is maintained, the radius r may be of any value, for example, about 20 mm or 18 mm. Of course, the radius may be greater than 23 mm of the present standard. There is no problem in manufacturing such a disk.

The minimum value of the radius of the inner periphery of the reflection film described above with reference to FIG. 3C is determined by the standard set in the recording/reproducing apparatus (not shown) or the diameter of the central hole specific to the optical disk. The radius r of the inner periphery of the reflection film may be about 15 mm. So far as the compatibility is maintained, the radius r may be about 11 mm or 13 mm.

The radius r of the inner periphery of the label described above with reference to FIG. 4E may be of a value including a margin in consideration of deviation of printing, for example, about 15 mm. The inner radius r of the label may be greater than that of the recording film shown in FIG. 3B. In this case, however, the area of the label will be smaller. Therefore, it is preferable that the inner radius of the label is greater than that of the recording film.

In the optical disk 1 thus obtained, the reflection film is formed also near the central hole 1a of the optical disk 1. Therefore, even if the label is printed in a region near the central hole, the back surface of the label cannot be seen from the side of the recording film. Therefore, the appearance cannot be impaired.

The recording film 12 is formed outside the region having a radius of 23 mm, and the reflection film 13 is not formed next the central hole 1a. Therefore, the adhesive layer 31 directly connects the substrates near the central hole 1a, thereby assuring the mechanical strength of the inner peripheral portion, to which great stress is applied when the disk is handled. Consequently, delamination of the substrates along the recording film surface from the inner periphery does not occur.

Further, since the reflection film is formed near the central hole (innermost portion), the rigidity of the substrate is reinforced by the reflection film made of metal. Therefore, the substrate has a high tilt resistance. The optical disk obtained by adhering the two substrates also has a high tilt resistance.

In the above embodiment, the two substrates having the 0.6 mm thickness are adhered to each other. However, for example, a 0.1 mm thick cover layer may be adhered to a 1.1 mm thick substrate. In this case also, the same effect as described above can be obtained.

The present invention is not limited to the above-mentioned embodiment and can be variously modified when practiced without departing from the scope of the invention.

The recording film may be formed to extend to the innermost portion. In this case, it is necessary to format the recording film to the innermost portion. However, in the constant linear velocity recording mode, a considerable time is required to format the area in the innermost portion around the circle of the r=12 mm due to various limitations, such as wobbling acceleration. This formatting process reduces the productivity and increases the costs.

In the present invention, the recording film conforms to the current standard, while only the reflection film extends to the innermost portion. Therefore, a new problem will not occur.

As has been described in detail above, in the optical disk of the present invention, the reflection film extends to the innermost portion around the central hole. Therefore, even if the label is printed on a portion near the central hole, the undersurface of the label cannot be seen from the side of the recording film. Therefore, the appearance of the optical disk cannot be impaired.

In addition, since the adhesive layer is directly brought into contact with the substrates near the central hole, the strength of the inner peripheral portion, to which great stress is applied when the disk is handled, is assured. Consequently, delamination of the substrates along the recording film surface from the inner periphery does not occur.

Further, since the reflection film is formed near the central hole (innermost portion), the rigidity of the substrate is reinforced by the reflection film made of metal. Therefore, the substrate having a high tilt resistance is obtained.

What is claimed is:

1. A rewritable laminated optical disk having a first substrate including a rewritable recording film and a reflection film which reflects light radiated from the recording film, and a second substrate including a visible information indicating region, the first and second substrates being adhered to each other by an adhesive layer, wherein
the recording film in the first substrate has an inner periphery having a radius of 16 mm to 24 mm, and the reflection film has an inner periphery having a radius of 11 mm to 15 mm.

2. The optical disk according to claim 1, wherein the visible information indicating region in the second substrate has an inner periphery of a radius smaller than that of the recording film and greater than that of the reflection film.

3. The optical disk according to claim 2, wherein the inner periphery of the visible information indicating region is greater than that of the reflection film by a margin defined in consideration of an amount of deviation which occurs in a printing process.

4. A recording medium comprising:
a first substrate, a reflection film which reflects light and has an inner periphery at a predetermined distance outside from a central hole and a recording film which records information upon radiation of light thereon and has an inner periphery at a predetermined distance outside from the reflection film;
a second substrate having an opening substantially concentric to the central hole of the first substrate and substantially same in diameter as the central hole, and a visible information indicating region which has an inner periphery at a predetermined distance outside from the reflection film; and
an adhesive layer which is interposed between the first and second substrates and adheres the first and second substrates such that the opening substantially coincides with the central hole.

5. The recording medium according to claim 4, wherein the inner periphery of the visible information indicating region in the second substrate is defined inside the inner periphery of the recording film in the first substrate and outside the inner periphery of the reflection film in the first substrate.

6. The recording medium according to claim 4, wherein the inner periphery of the visible information indicating region in the second substrate is greater than that of the reflection film by a margin defined in consideration of an amount of deviation which occurs in a printing process.

7. The recording medium according to claim 4, wherein the inner periphery of the visible information indicating region in the second substrate has a radius at least 1 mm greater than that of the reflection film in the first substrate.

8. An optical disk manufacturing method for manufacturing an optical disk of rewritable laminated type, comprising:
forming a recording film on a first substrate with a first mask covering at least a central hole of the optical disk; and
forming a reflection film on the first substrate with a second mask covering at least the central hole and having a radius different from that of the first mask.

9. The optical disk manufacturing method according to claim 8, wherein the first mask for use in forming the recording film has a radius greater than that of the second mask for use in forming the reflection film.

10. The optical disk manufacturing method according to claim 8, wherein the second mask for use in forming the reflection film is greater in radius than the central hole and smaller in radius than an inner periphery of a visible information recording region of a second substrate to be laminated on the first substrate.

11. An optical disk manufacturing method comprising:
forming a first thin film on a first substrate having predetermined outer and inner diameters with a first mask of a first radius arranged near a central hole of the first substrate, the first substrate having pits corresponding to physical information and a guide groove;
forming a second thin film on the first substrate with a second mask in place of the first mask, the second mask having a second radius smaller than the first radius;
applying a predetermined amount of adhesive to at least one of the second thin film and an exposed portion of the first substrate;
superposing a second substrate on the first substrate in association with the central hole of the first substrate and hardening the adhesive; and
recording visible information on a non-adhesive surface of the second substrate, thereby forming a visible information indicating region.

12. The optical disk manufacturing method according to claim 11, wherein the visible information indicating region has an inner periphery of a radius greater than that of the second radius.

13. The optical disk manufacturing method according to claim 11, wherein the visible information indicating region has a diameter smaller than that of the first mask.

14. A recording medium manufacturing method comprising:
forming a first thin film on a first substrate having predetermined outer and inner diameters with a first mask of a first radius arranged near a central hole of the first substrate;
thereafter exchanging the first mask with a second mask having a second radius smaller than the first radius; and
thereafter forming a second thin film on the first substrate.

15. The recording medium manufacturing method according to claim 14, wherein the first thin film is a rewritable recording film and the second thin film is a reflection film.
